(19) United States
(12) Patent Application Publication
(10) Pub. No.: US 2017/0362798 A1
(43) Pub. Date: Dec. 21, 2017

(54) SYSTEM AND METHOD TO DRIVE VACUUM EXCAVATOR

(71) Applicant: VAC-TRON EQUIPMENT, LLC, Okahumpka, FL (US)

(72) Inventor: Don M. BUCKNER, Okahumpka, FL (US)

(21) Appl. No.: 15/623,766

(22) Filed: Jun. 15, 2017

Related U.S. Application Data
(60) Provisional application No. 62/350,494, filed on Jun. 15, 2016.

(51) Int. Cl. E02F 9/20; B60K 17/28; E02F 3/90; B60P 1/60; E02F 3/88; E02F 5/00; B08B 5/04; A47L 7/00

(52) U.S. Cl. CPC E02F 9/202; B60P 1/60; B60K 17/28; E02F 3/8816; E02F 3/90; B08B 5/04; A47L 7/0004; E02F 5/00

(57) ABSTRACT

A system to drive vacuum equipment on a truck having an engine and a transmission includes a power take-off (PTO) unit configured to be coupled to a PTO port located on a side of the transmission. The system also includes a PTO shaft coupled to the PTO unit, vacuum equipment mounted to the truck, and a first gear box coupled to the PTO shaft and the first gear box configured to transfer power to the vacuum equipment. In addition, the system includes at least one belt coupled to the gear box, where the at least one belt drives additional auxiliary equipment. The additional auxiliary equipment comprises at least one of a water pump and a hydraulic pump, where the hydraulic pump is configured to stop and reverse a flow of hydraulic fluid to stop and reverse a rotational direction of air through the blower.

### CROSS-REFERENCE TO RELATED APPLICATIONS

This application claims priority to U.S. provisional application Ser. No. 62/350,494 filed on Jun. 15, 2016, all the contents of which are herein incorporated by reference.

### TECHNICAL FIELD

The present invention relates to the field of vacuum excavation, and, more particularly, to a system and method to drive a vacuum excavator.

### BACKGROUND

Industrial vacuum equipment has dozens of wet and dry uses such as locating underground utilities (potholing), hydro excavation, air excavation and vacuum excavation. In addition, the equipment can be used for directional drilling slurry removal, industrial clean-up, waste clean-up, lateral and storm drain clean-out, oil spill clean-up and other natural disaster clean-up applications, signs and headstone setting, for example. The vacuum equipment may be mounted to a truck or trailer and is typically powered by gas or diesel engines.

A dedicated engine may be mounted alongside the vacuum equipment to power the equipment. The truck could include a transmission-driven power take-off for driving the equipment and the engine can be used to power both the truck and the auxiliary equipment. A split shaft transfer cases is one type of PTO that has been used to allow the engine to power either the rear wheels or the deck equipment. When driving, the engine power is connected straight through to the drive axle. In the PTO position, the axle drive shaft is disengaged and the engine power is re-directed up through the gear train to outputs to operate various equipment.

A shortcoming of the prior art is the difficulty and expense in adapting a truck transmission to a power take-off.

### SUMMARY

In view of the foregoing background, it is therefore an object of the present invention to provide a system to drive a vacuum excavator that is easy and cost effective to implement. The system to drive vacuum equipment on a truck having an engine and a transmission includes a power take-off (PTO) unit configured to be coupled to a PTO port located on a side of the transmission. The system also includes a PTO shaft coupled to the PTO unit, vacuum equipment mounted to the truck, and a first gear box coupled to the PTO shaft and the first gear box configured to transfer power to the vacuum equipment. In addition, the system includes at least one belt coupled to the gear box, wherein the at least one belt drives additional auxiliary equipment. The additional auxiliary equipment comprises at least one of a water pump and a hydraulic pump, where the hydraulic pump is configured to stop and reverse a flow of hydraulic fluid to stop and reverse a rotational direction of air through the blower.

In another embodiment, a method to drive a vacuum excavator is disclosed. The method to drive vacuum equipment on a truck having an engine and a transmission includes coupling a power take-off (PTO) unit to a PTO port located on a side of the transmission, coupling a PTO shaft to the PTO unit, and transferring power to the vacuum equipment mounted to the truck via a first gear box coupled to the PTO shaft. The method also includes driving a hydraulic pump coupled to a blower, and controlling a direction of flow of hydraulic fluid of the hydraulic pump in order to control a direction of air flow through the blower.

### BRIEF DESCRIPTION OF THE DRAWINGS

FIG. 1 is a top perspective view of a truck and vacuum equipment mounted thereon;

FIG. 2 is a partial right side elevational view of the truck and system to drive the vacuum equipment of FIG. 1;

FIG. 3 is a perspective left side view of the system to drive the vacuum equipment shown in FIG. 2; and

FIG. 4 is a flow diagram of a method to drive vacuum equipment.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

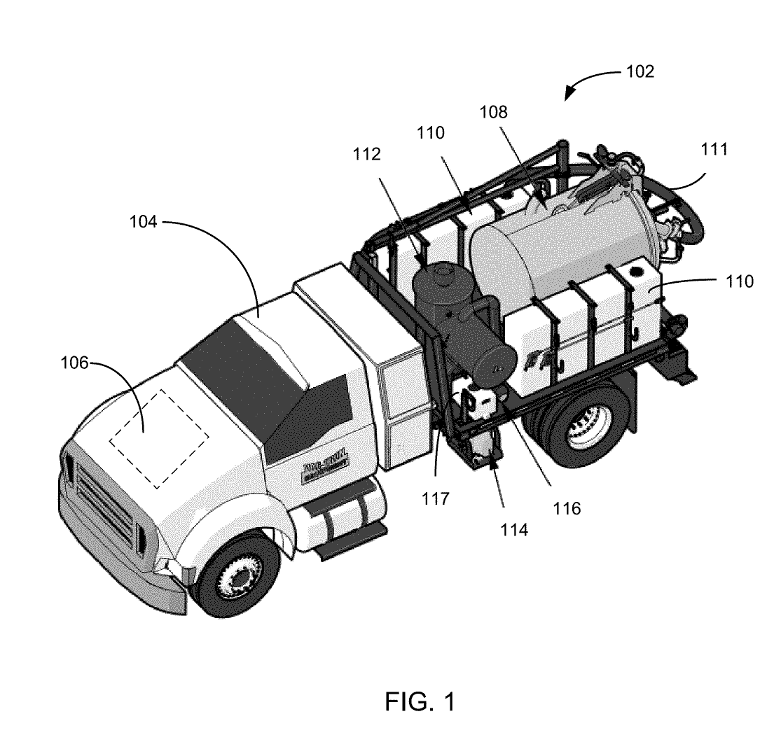

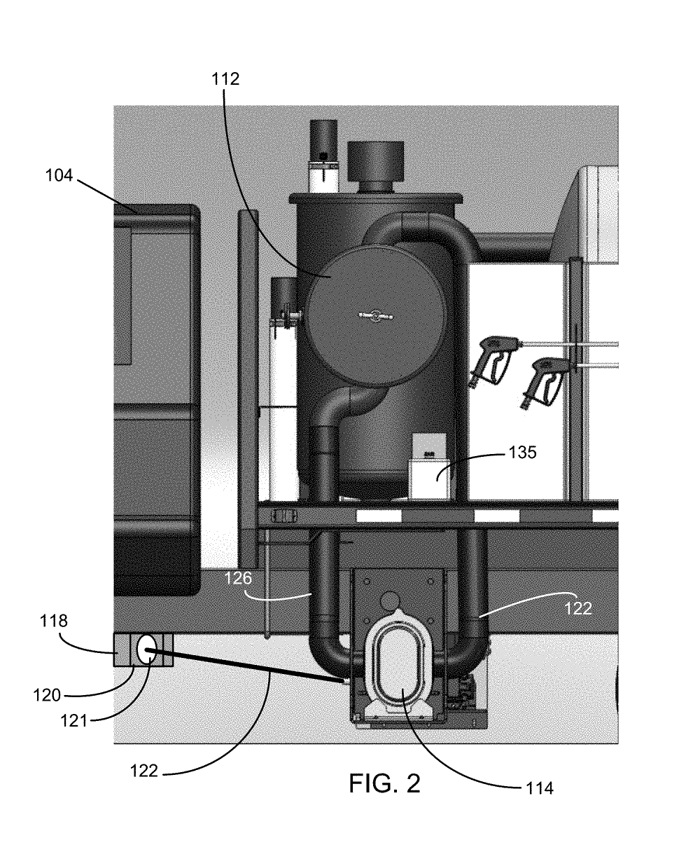

Referring now to FIGS. 1-3, a particular illustrative embodiment of a system to drive vacuum equipment 102 on a truck 104 having an engine 106 and a transmission 118 is disclosed. The system includes a power take-off (PTO) unit 120 coupled to a PTO port 121 located on a side of the transmission 118. A PTO shaft 122 is coupled to the PTO unit 120. The vacuum equipment 102 mounted to the truck 104 is coupled to the PTO shaft 122 and configured to be driven by the PTO shaft 122. Substantially all available horsepower of the engine 106 is transferred to the vacuum equipment 102 via the PTO shaft 122.

A debris tank 108 is also mounted to the truck 104 and a vacuum hose 111 is coupled to the debris tank 108 by an inlet of the debris tank 108. The debris tank 108 can be placed under a vacuum by a blower 114 coupled to the debris tank 108. In turn, the vacuum hose 111 is also coupled to the debris tank 108 and has suction that is used to excavate materials into the debris tank 108. A filter housing 112 is coupled to the blower 114.

In a particular embodiment, the blower 114 may be a positive displacement pump, for example. The blower 114 is driven by a hydraulic pump 116 coupled to the PTO unit 120. In particular, the hydraulic pump 116 is configured to control the direction of air flow through the blower 114 (and in turn the debris tank 108 and vacuum hose 111) in response to a direction of the flow of hydraulic fluid through the hydraulic pump 116. As the hydraulic pump 116 is driven by the PTO unit 120, the direction of hydraulic fluid is selected so that the blower 114 is also moving air flow in a first direction (e.g., providing a vacuum).

For example, a first conduit 126 is coupled to a first port of the blower 114 and a second conduit 122 is coupled to a second port of the blower 114. The first conduit 126 can be for suction and the second conduit 122 can be for discharge when the air flow is in first direction. When the direction of the hydraulic fluid is reversed, the first conduit 126 then becomes the discharge and the second conduit 122 is the suction. The direction of flow of the hydraulic fluid of the hydraulic pump 116 can be reversed using valving of the hydraulic pump 116 known to those in the art so that as a result the air flow of the blower 114 can also be reversed.

Accordingly, a significant advantage is that the speed and rotation of the hydraulic pump 116 can be varied, which thus controls the volume and direction of air from the blower 114. More importantly, changing the flow of hydraulic fluid through the hydraulic pump 116 can be used to reverse the air flow in order to dislodge rocks that may be lodged inside the vacuum hose 111 and also can be used to pick up rocks out of a hole and drop them by stopping the air flow and vacuum.

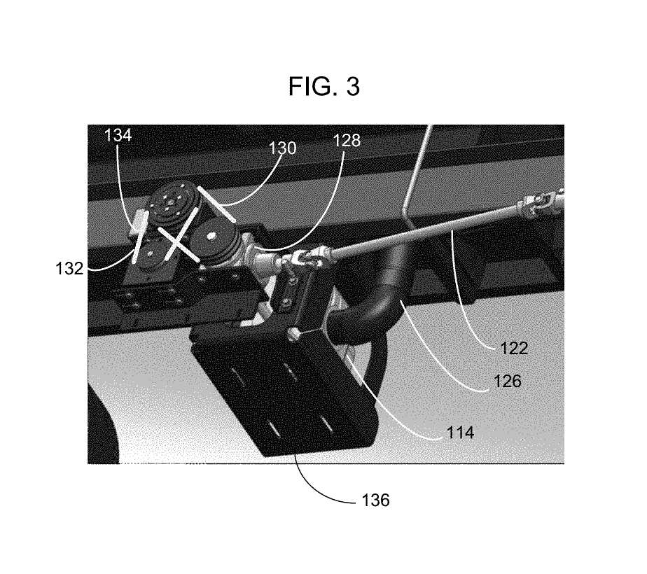

Referring now to FIG. 3, a first gear box 128 may be coupled to the PTO shaft 122 and the first gear 128 box is configured to transfer power to the vacuum equipment 102. Belts 130, 132 may be coupled to the first gear box 128, where the belts 130, 132 drive additional auxiliary equipment such as the hydraulic pump 116 described above and a water pump 117. The water pump 117 is in fluid communication with water tanks 110 that are carried by the truck 104. The water pump 117 may include user operated controls configured to adjust an amount of water used during hydro excavation.

A second gear box 134 may also be coupled to the first gear box 132, where the second gear box 134 may be configured to transfer power to an air compressor 135 used to generate high pressure air for the excavation process and break up soil. A frame 136 may be used to support and hold the blower 115 and the first and second gear boxes 128, 134 under the truck 104 in order to be in communication with the PTO shaft 122, which is also under the truck 104.

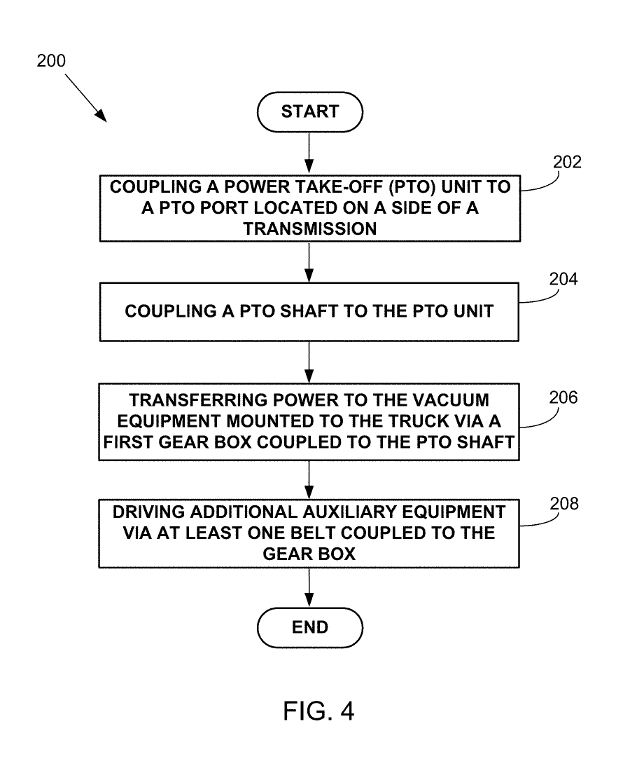

Referring now to FIG. 4, a method to drive vacuum equipment on a truck having an engine and a transmission includes coupling a power take-off (PTO) unit to a PTO port located on a side of the transmission, at 202. The method also includes, at 204, coupling a PTO shaft to the PTO unit. Moving to 206, the method includes transferring power to the vacuum equipment mounted to the truck via a first gear box coupled to the PTO shaft, and driving additional auxiliary equipment via at least one belt coupled to the gear box, at 208. In addition, the method includes driving a blower using a hydraulic pump coupled to the PTO unit, where the blower is configured to provide suction or discharge air flow to a vacuum hose in response to a direction of hydraulic fluid flowing through the hydraulic pump.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A system to drive vacuum equipment on a truck having an engine and a transmission, the system comprising:
a power take-off (PTO) unit configured to be coupled to a PTO port located on a side of the transmission;
a PTO shaft coupled to the PTO unit; and
vacuum equipment mounted to the truck, the vacuum equipment coupled to the PTO shaft and configured to be driven by the PTO shaft.

2. The system of claim 1, wherein substantially all available horsepower of the engine is transferred to the vacuum equipment via the PTO shaft.

3. The system of claim 1, wherein the vacuum equipment comprises a blower.

4. The system of claim 3, wherein the blower is a positive displacement pump.

5. The system of claim 1, further comprising a first gear box coupled to the PTO shaft and the first gear box configured to transfer power to the vacuum equipment.

6. The system of claim 3, further comprising at least one belt coupled to the gear box, wherein the at least one belt drives additional auxiliary equipment.

7. The system of claim 6, wherein the additional auxiliary equipment comprises at least one of a water pump and a hydraulic pump.

8. The system of claim 7, wherein the hydraulic pump is configured to stop and reverse a flow of hydraulic fluid to stop and reverse a rotational direction of air through the blower.

9. The system of claim 7, wherein the water pump comprises user operated controls configured to adjust an amount of water used during hydro excavation.

10. The system of claim 5, further comprising a second gear box coupled to the first gear box, the second gear box configured to transfer power to an air compressor.

11. A system to drive vacuum equipment on a truck having an engine and a transmission, the system comprising:
a power take-off (PTO) unit configured to be coupled to a PTO port located on a side of the transmission;
a PTO shaft coupled to the PTO unit;
vacuum equipment mounted to the truck;
a first gear box coupled to the PTO shaft and the first gear box configured to transfer power to the vacuum equipment; and
at least one belt coupled to the gear box, wherein the at least one belt drives additional auxiliary equipment.

12. The system of claim 11, wherein substantially all available horsepower of the engine is transferred to the vacuum equipment via the PTO shaft.

13. The system of claim 11, wherein the vacuum equipment comprises a blower.

14. The system of claim 13, wherein the blower is a positive displacement pump.

15. The system of claim 13, further comprising a hydraulic pump configured to control a direction of flow of hydraulic fluid in order to control a direction of air through the blower.

16. The system of claim 1, further comprising:
a second gear box coupled to the first gear box; and
an air compressor, wherein the second gear box is configured to transfer power to the air compressor.

17. A method to drive vacuum equipment on a truck having an engine and a transmission, the method comprising:
coupling a power take-off (PTO) unit to a PTO port located on a side of the transmission;
coupling a PTO shaft to the PTO unit;
transferring power to the vacuum equipment mounted to the truck via a first gear box coupled to the PTO shaft; and
driving a hydraulic pump via at least one belt coupled to the gear box.

18. The method of claim 17, wherein the vacuum equipment comprises a blower.

19. The method of claim 18, wherein the vacuum pump is a positive displacement pump.

20. The method of claim 18, further comprising controlling a direction of flow of hydraulic fluid of the hydraulic pump in order to control a direction of air flow through the blower.
